(19) United States
(12) Patent Application Publication
(10) Pub. No.: US 2019/0011043 A1
(43) Pub. Date: Jan. 10, 2019

(54) TRANSMISSION DEVICE

(71) Applicant: AISIN AW CO., LTD., Anjo-shi, Aichi-ken (JP)

(72) Inventors: Mitsuru TAKAHASHI, Hekinan (JP); Hiromitsu KUBOYAMA, Nishio (JP); Kazuo KOMURA, Chiryu (JP)

(73) Assignee: AISIN AW CO., LTD., Anjo-shi, Aichi-ken (JP)

(21) Appl. No.: 16/064,559

(22) PCT Filed: Dec. 26, 2016
(86) PCT No.: PCT/JP2016/088754

§ 371 Date: Jun. 21, 2018

(30) Foreign Application Priority Data
Feb. 4, 2016 (JP) 2016-019776

(51) Int. Cl. F16H 61/02; F16H 63/50; F16H 61/16; F16H 61/00; B60W 10/02; B60W 10/11

(52) U.S. Cl. CPC F16H 61/02; F16H 63/50; F16H 61/16; B60W 2510/1075; B60W 10/02; B60W 10/11; F16H 61/0021

(57) ABSTRACT

In a transmission device having a hydraulic control device that releases working oil accumulated in an accumulator and supplies the working oil to a hydraulic servo for starting an engine, the automatic stopping of the engine is permitted when an accumulator internal pressure becomes equal to more than a stopping permission threshold. The stopping permission threshold is changed with a correction value according to a state of the vehicle. Thus, it is possible to optimize the accumulator internal pressure that permits automatic stopping of the engine, to ensure the accumulator internal pressure necessary for starting the engine and the vehicle again and achieve prompt automatic stopping of the engine.

### CROSS REFERENCE TO RELATED APPLICATIONS

This application is a National Stage of International Application No. PCT/JP2016/088754 filed Dec. 26, 2016, claiming priority based on Japanese Patent Application No. 2016-019776, filed Feb. 4, 2016.

### TECHNICAL FIELD

Aspects of the application relate to a transmission device.

### BACKGROUND ART

There has hitherto been known a transmission device of this type provided with a hydraulic control device which includes: an oil pump that is operated using power from an engine; a forward clutch connected to the oil pump via an oil passage; an accumulator provided in a branch oil passage that branches from the oil passage; and a switching valve capable of disconnecting the accumulator and the oil passage. The hydraulic control device closes the switching valve when the engine stops in order to maintain hydraulic pressure accumulated in the accumulator during engine operation, and opens the switching valve when the engine restarts in order to supply hydraulic pressure accumulated in the accumulator to the forward clutch (for example, see Patent Document 1). In this transmission device, when the automatic stopping conditions for the engine are satisfied, automatic stopping of the engine is prohibited if there is no accumulated hydraulic pressure in the accumulator. If there is accumulated hydraulic pressure in the accumulator, the executing period of automatic stopping of the engine (automatic stopping period) is restricted depending on the hydraulic pressure.

Patent Document 1: Japanese Patent Application Publication No. 2000-313252 (JP 2000-313252 A)

### SUMMARY OF THE APPLICATION

In the transmission device described above, the automatic stopping period is short when the accumulated hydraulic pressure in the accumulator is low. This is because automatic stopping of the engine is permitted when there is accumulated hydraulic pressure in the accumulator. Thus, the engine may be started at a timing unintended by the driver, and give the driver a sense of discomfort. Automatic stopping of the engine may not be permitted unless the accumulated hydraulic pressure in the accumulator reaches the target hydraulic pressure. However, if the target hydraulic pressure becomes excessive, the opportunity of automatic stopping of the engine may be unnecessarily decreased.

One aspect of a transmission device of the disclosure is to make a target hydraulic pressure of an accumulator for permitting automatic stopping of a motor appropriate, to ensure hydraulic pressure in the accumulator and achieve prompt automatic stopping of the motor.

The disclosure describes the following means to achieve the aspect described above.

The transmission device of the disclosure which is mounted on a vehicle having a motor configured to automatically stop and automatically start, which shifts power from the motor with a shift speed that is changed by engagement and disengagement of a plurality of engagement elements, and which transmits the power to the axle, including: a hydraulic control device which has a pump that supplies working oil using power from the motor, and an accumulator that accumulates the working oil supplied from the pump, and which controls the working oil supplied from the pump or the accumulator to engage the engagement elements; a start control unit which controls the hydraulic control device so that the working oil accumulated in the accumulator is released to be supplied to a hydraulic servo of a prescribed engagement element of the engagement elements, when the motor that automatically stopped starts up with a request for vehicle travel; an accumulator hydraulic pressure acquisition unit which obtains hydraulic pressure of working oil accumulated in the accumulator; an automatic stop permission unit that permits execution of automatic stopping of the motor, when a prescribed condition is satisfied, the condition including that at least the obtained hydraulic pressure in the accumulator has reached target hydraulic pressure during operation of the motor; and a target hydraulic pressure changing unit which changes the target hydraulic pressure based on a state of the vehicle.

The transmission device of the disclosure permits execution of automatic stopping of the motor when the prescribed condition is satisfied, the condition including that at least the hydraulic pressure in the accumulator has reached the target hydraulic pressure during operation of the motor. In this transmission device, the target hydraulic pressure is changed based on the state of the vehicle. By making the target hydraulic pressure variable in this way, it is possible to lower the target hydraulic pressure and cause the motor to automatically stop promptly, when the vehicle is in such a state that the accumulated pressure of the accumulator may be low. When the vehicle is in a state in which a lot of accumulated pressure is needed in the accumulator, it is possible to increase the target hydraulic pressure and sufficiently ensure accumulated pressure in the accumulator. As a result, it is possible to ensure accumulated pressure of the accumulator and achieve a prompt automatic stopping of the motor. Here, to “release working oil accumulated in the accumulator, and supply working oil to the hydraulic servo of the prescribed engagement element of the engagement elements” includes cases when working oil is supplied to the hydraulic servo to a degree in which a friction member of the engagement element is engaged without a slip (fully engaged), when working oil is supplied to the hydraulic servo to a degree in which the friction member of the engagement element is engaged with a slip (half engaged), and when working oil is supplied to the hydraulic servo until right before the friction member of the engagement element slips (up to a piston stroke end).

### BRIEF DESCRIPTION OF THE DRAWINGS

FIG. 1 is a schematic diagram of the overall structure of a vehicle 10 mounted with a transmission device 20 according to an exemplary embodiment.

FIG. 2 is a schematic diagram of the overall mechanical structure of the transmission device 20 that includes an automatic transmission 25.

FIG. 3 is an explanatory diagram that shows an operation table representing relations of each shift speed of the automatic transmission 25 with each of the operating states of clutches C1 to C4, brakes B1 and B2, and a one-way clutch F1.

FIG. 4 is a schematic diagram of the structure of a hydraulic control device 60.

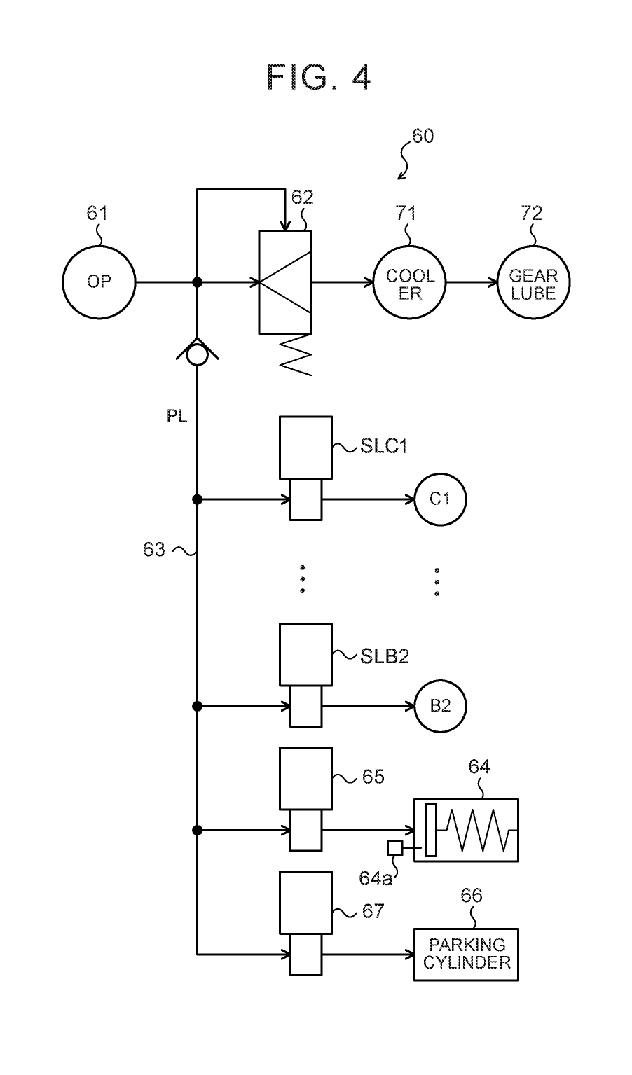

FIG. 5 is a flowchart of an example of an engine stopping permission determination routine executed by a transmission ECU 80.

FIG. 6 is an explanatory diagram of the relationship between a stopping permission threshold and an accumulator internal pressure Pacc.

### PREFERRED EMBODIMENTS

Next, an embodiment of the present application will be described below with reference to the drawings.

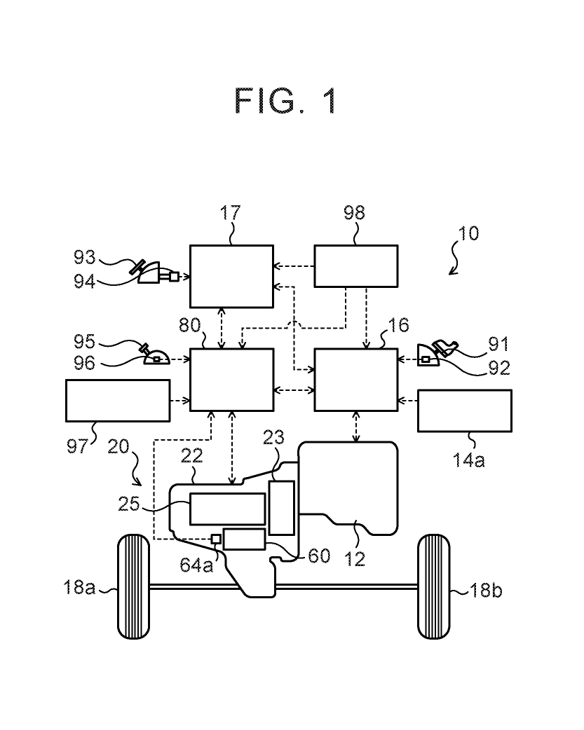

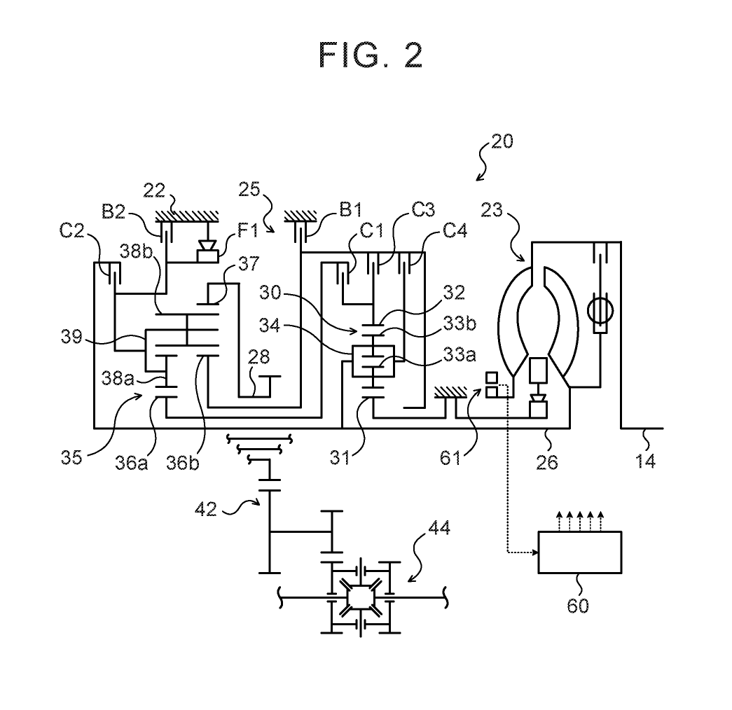

FIG. 1 is a schematic diagram of the structure of a vehicle 10 mounted with a transmission device 20 according to an exemplary embodiment of the disclosure. FIG. 2 is a schematic diagram of the mechanical structure of the transmission device 20 that includes an automatic transmission 25.

As shown in FIG. 1 and FIG. 2, the vehicle 10 includes: an engine 12; an engine electronic control unit (hereinafter referred to as an engine ECU) 16 that controls the operation of the engine 12; a hydraulic transmission device 23 mounted on a crankshaft 14 of the engine 12; the stepped automatic transmission 25 in which an input shaft 26 is connected to an output side of the hydraulic transmission device 23 and an output shaft 28 is connected to driving wheels 18a, 18b via a gear mechanism 42 and a differential gear 44, and power input from the input shaft 26 is shifted and transmitted to the output shaft 28; a hydraulic control device 60 that supplies working oil to the hydraulic transmission device 23 and the automatic transmission 25; a transmission electronic control unit (hereinafter referred to as a transmission ECU) 80 that controls the hydraulic transmission device 23 and the automatic transmission 25 by controlling the hydraulic control device 60; and a brake electronic control unit (hereinafter referred to as a brake ECU) 17 that controls an electronically-controlled hydraulic brake unit that is not shown. Here, mainly the automatic transmission 25, the hydraulic control device 60, and the transmission ECU 80 correspond to the transmission device 20.

The engine ECU 16 is configured as a microprocessor that includes a CPU as a main component, and includes, other than the CPU, a ROM that stores a processing program, a RAM that temporarily stores data, an input/output port, and a communication port. The engine ECU 16 receives, via input ports, signals from various sensors that detect the operation state of the engine 12, such as a signal indicating an engine rotational speed Ne from a rotational speed sensor 14a that is mounted on the crankshaft 14. The engine ECU 16 also receives, via input ports, signals such as the accelerator operation amount Acc from an accelerator pedal position sensor 92 that detects the accelerator operation amount Acc as the stepping amount of an accelerator pedal 91 and a vehicle speed V from a vehicle speed sensor 98. Signals such as a drive signal for a throttle motor that drives the throttle valve, a control signal for a fuel injection valve, and an ignition signal for a spark plug are output from the engine ECU 16 via the output port.

As shown in FIG. 2, the hydraulic transmission device 23 is structured as a hydraulic torque converter with a lockup clutch that has a pump impeller, a turbine runner, a stator, a one-way clutch, and a lockup clutch etc.

The automatic transmission 25 is structured as an eight-speed transmission. As shown in FIG. 2, the automatic transmission 25 includes a double pinion-type first planetary gear mechanism 30, a Ravigneaux-type second planetary gear mechanism 35, four clutches C1, C2, C3 and C4 and two brakes B1 and B2 for changing a power transmission path from the input side to the output side, and a one-way clutch F1.

The first planetary gear mechanism 30 of the automatic transmission 25 includes a sun gear 31 that is an external gear, a ring gear 32 that is an internal gear arranged concentrically with the sun gear 31, and a planetary carrier 34 that rotatably (turnably) and revolvably holds a plurality of sets of two pinion gears 33a, 33b that mesh with each other while one meshes with the sun gear 31 and the other meshes with the ring gear 32. As shown in the figure, the sun gear 31 of the first planetary gear mechanism 30 is fixed to a transmission case 22, and the planetary carrier 34 of the first planetary gear mechanism 30 is coupled so as to be rotatable together with the input shaft 26. The first planetary gear mechanism 30 is structured as a so-called speed reduction gear, and decelerates the power transferred to the planetary carrier 34 which serves as an input element to output the power from the ring gear 32 which serves as an output element.

The second planetary gear mechanism 35 of the automatic transmission 25 has a first sun gear 36a and a second sun gear 36b as external gears, a ring gear 37 as an internal gear placed concentrically with the first and second sun gears 36a, 36b, a plurality of short pinion gears 38a meshing with the first sun gear 36a, a plurality of long pinion gears 38b meshing with the second sun gear 36b and the short pinion gears 38a as well as the ring gear 37, and a planetary carrier 39 that rotatably (turnably) and revolvably holds the short pinion gears 38a and the long pinion gears 38b. The ring gear 37 of the second planetary gear mechanism 35 functions as an output member of the automatic transmission 25. The power transmitted from the input shaft 26 to the ring gear 37 is transmitted to the left and right driving wheels 18a, 18b via the gear mechanism 42 and the differential gear 44. The planetary carrier 39 is supported by the transmission case 22 via the one-way clutch F1, and the one-way clutch F1 permits the planetary carrier 39 to rotate only in one direction.

The clutches C1 to C4 are each structured as a multi-plate friction hydraulic clutch that has a piston, a plurality of friction plates and separator plates, and a hydraulic servo formed by an oil chamber to which working oil is supplied etc., and that can connect or disconnect two rotation systems. The clutch C1 can connect the ring gear 32 of the first planetary gear mechanism 30 and the first sun gear 36a of the second planetary gear mechanism 35 to each other, and disconnect the ring gear 32 and the first sun gear 36a from each other. The clutch C2 can connect the input shaft 26 and the planetary carrier 39 of the second planetary gear mechanism 35 to each other, and disconnect the input shaft 26 and the planetary carrier 39 from each other. The clutch C3 can connect the ring gear 32 of the first planetary gear mechanism 30 and the second sun gear 36b of the second planetary gear mechanism 35 to each other, and disconnect the ring gear 32 and the second sun gear 36b from each other. The clutch C4 can connect the planetary carrier 34 of the first planetary gear mechanism 30 and the second sun gear 36b of the second planetary gear mechanism 35 to each other, and disconnect the planetary carrier 34 and the second sun gear 36b from each other.

The brakes B1, B2 are both structured as a multi-plate friction hydraulic brake that has friction plates and separator plates, and a hydraulic servo structured by an oil chamber to which working oil is supplied etc., and that can connect and disconnect a rotation system to a fixed system. The brake B1 can make the second sun gear 36b of the second planetary gear mechanism 35 stationary with respect to the transmission case 22, and make the second sun gear 36b non-stationary with respect to the transmission case 22. The brake B2 can make the planetary carrier 39 of the second planetary gear mechanism 35 stationary with respect to the transmission case 22, and make the planetary carrier 39 non-stationary with respect to the transmission case 22.

The one-way clutch F1 has an inner race coupled (fixed) to the planetary carrier 39 of the second planetary gear mechanism 35, an outer race fixed to the transmission case 22, and a torque transmitting member (a plurality of sprags etc.) disposed between the inner race and the outer race, and permits the planetary carrier 39 to rotate in only one direction.

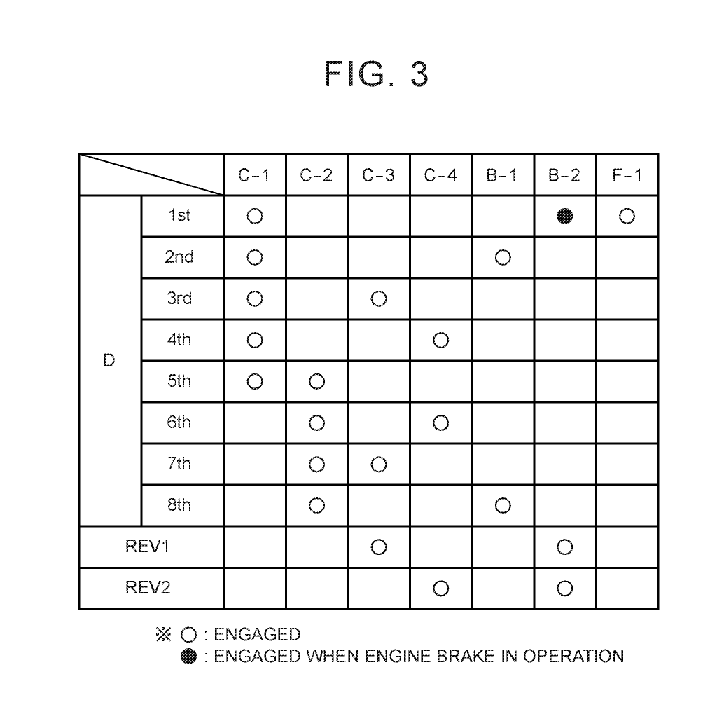

The clutches C1 to C4 and the brakes B1 and B2 operate with working oil supplied thereto and discharged therefrom by the hydraulic control device 60 described above. FIG. 3 shows an operation table representing relations of each shift speed of the automatic transmission 25 with each of the operating states of the clutches C1 to C4, the brakes B1 and B2, and the one-way clutch F1. The automatic transmission 25 places the clutches C1 to C4 and the brakes B1 and B2 in the states shown in the operation table of FIG. 3 so as to provide first to eighth forward shift speeds and first and second reverse shift speeds. Specifically, as shown in FIG. 3, the first forward speed is formed by engaging the clutch C1. When the engine brake is applied, the brake B2 is also engaged for the first forward speed. The second forward speed is formed by engaging the clutch C1 and the brake B1. The third forward speed is formed by engaging the clutch C1 and the clutch C3. The fourth forward speed is formed by engaging the clutch C1 and the clutch C4. The fifth forward speed is formed by engaging the clutch C1 and the clutch C2. The sixth forward speed is formed by engaging the clutch C2 and the clutch C4. The seventh forward speed is formed by engaging the clutch C2 and the clutch C3. The eighth forward speed is formed by engaging the clutch C2 and the brake B1. The first reverse speed is formed by engaging the clutch C3 and the brake B2. The second reverse speed is formed by engaging the clutch C4 and the brake B2.

The hydraulic control device 60 includes: an oil pump 61 that feeds working oil with pressure by the power of the engine 12; a regulator valve 62 that supplies a part of the working oil fed by the oil pump 61 with pressure to a cooler 71 and an object 72 to be lubricated such as a gear or a bearing while regulating the pressure of the working oil and generates line pressure PL in a line pressure oil passage 63; linear solenoid valves SLC1 to SLC4, SLB1 and SLB2 (SLC2 to SLC4 not shown) each regulates line pressure PL of the line pressure oil passage 63 and supplies it to each of the hydraulic servos of the clutches C1 to C4 and the brakes B1, B2; an accumulator 64 that is an accumulator for accumulating hydraulic pressure from the oil pump 61; an on/off solenoid valve 65 that allows/blocks communication between the accumulator 64 and the line pressure oil passage 63; and an on/off solenoid valve 67 that allows/blocks communication between a parking cylinder 66 that drives a parking pawl included in the parking lock device and the line pressure oil passage 63.

In the embodiment, the parking lock device has a parking gear provided on a rotational shaft of the automatic transmission 25, the parking pawl, a spring, and the parking cylinder etc. The parking lock device is structured as a shift-by-wire type parking lock device in which a parking lock is executed/released by a hydraulic actuator. The parking pawl is pressed against the parking gear by force of the spring, so as to be engaged with the parking gear. The parking pawl is driven by the parking cylinder 66 with the line pressure PL supplied through the on/off solenoid valve 67, so as to be disengaged from the parking gear.

The transmission ECU 80 is configured as a microprocessor that includes a CPU as a main component, and includes, other than the CPU, a ROM that stores a processing program, a RAM that temporarily stores data, an input/output port, and a communication port. The transmission ECU 80 receives, via input ports, inputs such as an accumulator internal pressure Pacc from a pressure sensor 64a that detects the pressure inside the accumulator 64, a shift position SP from a shift position sensor 96 that detects the position of a shift lever 95, a switching signal from a snow mode switch 97 for starting the vehicle 10 at second forward speed or making the shift changing timing earlier than usual, and the vehicle speed V from the vehicle speed sensor 98. Control signals for the hydraulic control device 60 (linear solenoid valves SLC1, SLB2, on/off solenoid valve 65, 67) are output from the transmission ECU 80 via the output ports.

In the embodiment, a parking position (P position) for parking, a reverse position (R position) for reverse traveling, a neutral position (N position) that is neutral, and a normal driving position (D position) for forward traveling, are provided as the shift positions SP of the shift lever 95. When the shift lever 95 is shifted to the parking position, the transmission ECU 80 closes the on/off solenoid valve 67 and shuts off supply of hydraulic pressure to the parking cylinder 66, so that the parking pawl is engaged with the parking gear by the urging force of the spring. Thus, the parking lock is executed. When the shift lever 95 is shifted from the parking position to the other positions, the transmission ECU 80 opens the on/off solenoid valve 67 and supplies hydraulic pressure to the parking cylinder 66 so that the parking pawl is driven to be disengaged from the parking gear. Thus, the parking lock is released.

The engine ECU 16, the brake ECU 17, and the transmission ECU 80 are connected with one another through communication ports, and exchange with each other various control signals and data that are necessary for control. The transmission ECU 80 receives inputs such as the accelerator operation amount Acc from the accelerator pedal position sensor 92 via the engine ECU 16 through communication and a brake operation amount B from a brake pedal position sensor 94 that detects the stepping amount of a brake pedal 93 via the brake ECU 17 through communication.

In the vehicle 10 structured in this way, the engine ECU 16 executes idling stop control. The idling stop control stops fuel supply to the engine 12 so that the engine 12 automatically stops when the automatic stopping conditions for the engine 12 are satisfied, those conditions being the vehicle speed V is below a prescribed vehicle speed and the accelerator is off etc. The idling stop control also cranks the engine 12 so that the engine 12 automatically starts when the automatic starting conditions of the engine 12 are satisfied, those conditions being the engine 12 is automatically stopped, the brake is off, and the accelerator is on etc.

When the engine 12 is operating, the transmission ECU 80 opens the on/off solenoid valve 65 and accumulates the hydraulic pressure from the oil pump 61 that is operated by the power from the engine 12. When the engine 12 automatically stops, the transmission ECU 80 closes the on/off solenoid valve 65 and holds the hydraulic pressure accumulated in the accumulator 64. When the engine 12 automatically starts again, the transmission ECU 80 opens the on/off solenoid valve 65 and releases the hydraulic pressure (accumulator internal pressure Pacc) accumulated in the accumulator 64 to the line pressure oil passage 63. Then, the transmission ECU 80 executes engagement control to engage the clutch C1 to form the first forward speed using the accumulator internal pressure Pacc or engagement control that engages the clutch C1 and the brake B1 to form the second forward clutch, until the engine 12 starts and the oil pump 61 operates. In the engagement control of the clutch C1 (brake B1) that uses the accumulator internal pressure Pacc, the engagement may be controlled so that working oil is supplied to the hydraulic servo of the clutch C1 (brake B1) until the friction material (friction plate, separator plate) are engaged without a slip (fully engaged). Additionally, the engagement may be controlled so that working oil is supplied to the hydraulic servo of the clutch C1 (brake B1) until the friction material is engaged with a slip (half engaged). The engagement may also be controlled so that working oil is supplied to the clutch C1 (brake B1) until right before the friction material slips (up to a piston stroke end).

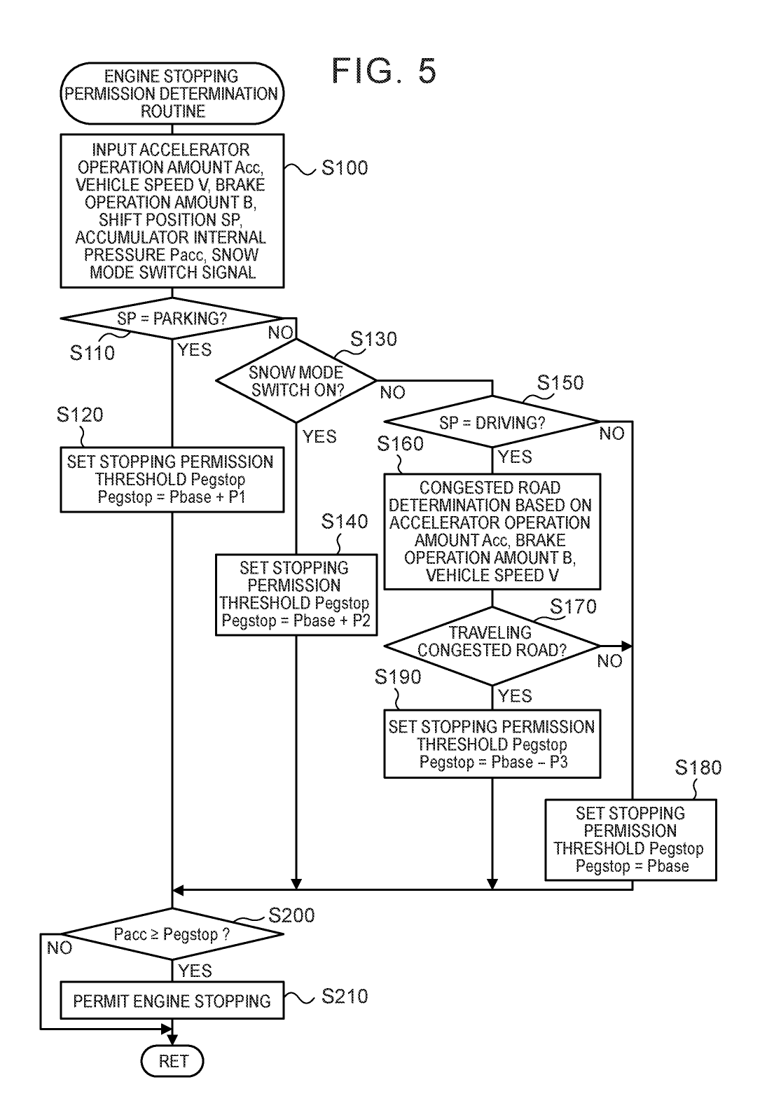

Next, the operation of the transmission device 20 according to the embodiment thus structured will be described, especially the operation of the transmission device 20 when automatic stopping of the engine 12 is permitted or prohibited. FIG. 5 is a flowchart of an example of an engine stopping permission determination routine. This routine is repeatedly executed every predetermined time by the transmission ECU 80.

When the engine stopping permission determination routine is executed, the CPU of the transmission ECU 80 first executes input processing of necessary data such as the accelerator operation amount Acc, the vehicle speed V, the brake operation amount B, the shift position SP, the accumulator internal pressure Pacc, and the snow mode switching signal.

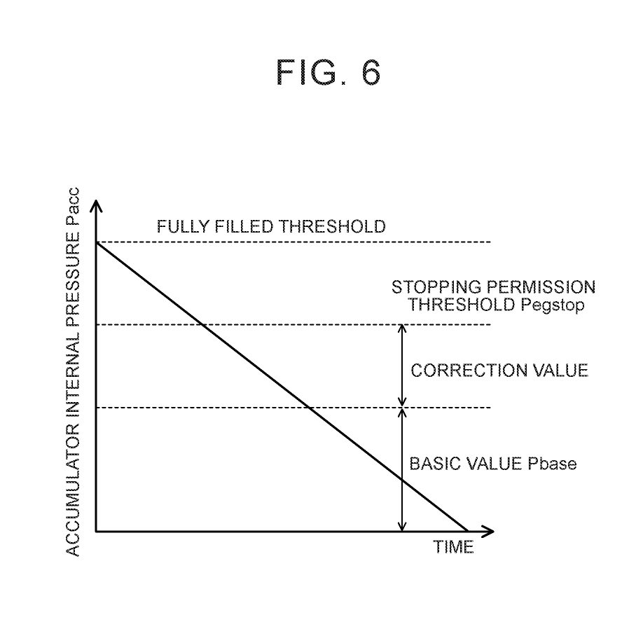

When receiving input of the data, the transmission ECU 80 determines whether the input shift position SP is the parking position (step S110). When the shift position SP is determined to be in the parking position, a sum of a basic value Pbase and a correction value P1 is set as a stopping permission threshold Pegstop (step S120). FIG. 6 is an explanatory diagram of the relationship between a stopping permission threshold and an accumulator internal pressure Pacc. The stopping permission threshold Pegstop is the lower limit value of the accumulator internal pressure Pacc that permits automatic stopping of the engine 12, and can be obtained by addition or subtraction of the correction value P1 to P3 to or from the basic value Pbase when necessary. The basic value Pbase represents the accumulated pressure amount that is necessary for the hydraulic pressure necessary for preparation for forming the first forward speed (hydraulic pressure that can hold the clutch C1 at the stroke end) to remain in the accumulator 64, when the prescribed time (automatic stopping time) has passed since the engine 12 had stopped. The basic value Pbase can be set based on the value of the standard automatic stopping time of the engine 12 multiplied by the leakage rate of the accumulator 64. The correction value P1 represents the accumulated pressure amount necessary for supplying releasing pressure needed for releasing the parking lock to the parking cylinder 66 (necessary parking lock release pressure).

If the transmission ECU 80 determines that the shift position SP is not the parking position in step S110, the transmission ECU 80 then determines whether the snow mode switch 97 is on (step S130). If the transmission ECU 80 determines that the snow mode switch 97 is on, the transmission ECU 80 sets the sum of the basic value Pbase and a correction value P2 as the stopping permission threshold Pegstop (step S140). If the snow mode switch 97 is off, the transmission ECU 80 causes the clutch C1 to be engaged to form the first forward speed when the engine 12 that automatically stopped starts to start the vehicle 10. If the snow mode switch 97 is on, the transmission ECU 80 causes the brake B1 as well as the clutch C1 to be engaged to form the second forward speed when the engine 12 that automatically stopped starts to start the vehicle 10. The correction value P2 represents the accumulated pressure amount that is necessary for the hydraulic pressure necessary for preparation for forming the second forward speed in addition to the clutch C1 (hydraulic pressure that can hold the brake B1 at the stroke end) to remain in the accumulator 64 when the prescribed time (automatic stopping time) has passed since the engine 12 had stopped.

If the transmission ECU 80 determines that the snow mode switch 97 is not on, the transmission ECU 80 determines whether the shift position SP is the driving position (step S150). If the transmission ECU 80 determines that the shift position SP is the driving position, the transmission ECU 80 executes congested road determination based on the accelerator operation amount Acc, the brake operation amount B, and the vehicle speed V input in step S100 (step S160). The transmission ECU 80 then determines whether the determination result shows that the vehicle 10 is traveling along a congested road (step S170). The transmission ECU 80 can carry out congested road determination by monitoring, for example, operation frequency of the accelerator operation amount Acc and the brake operation amount B, and the vehicle speed V, to determine the traveling state in which low speed travel and stopping of the vehicle 10 are being repeated. If the transmission ECU 80 determines that the shift position SP is not the driving position in step S150, or that the vehicle 10 is not traveling along a congested road in step S170, the basic value Pbase is set as the stopping permission threshold Pegstop (step S180). If the transmission ECU 80 determines that the shift position SP is the driving position in step S150 and that the vehicle 10 is traveling along a congested road in step S170, a value obtained by subtracting a correction value P3 from the basic value Pbase is set as the stopping permission threshold Pegstop (step S190). When the vehicle 10 is traveling along a congested road, low speed travel and stopping are repeated. Thus, the engine 12 repeats automatic stopping and automatic starting at shorter time intervals than the standard automatic stopping time described above. Therefore, when the transmission ECU 80 does not permit automatic stopping of the engine 12 until the accumulator internal pressure Pacc reaches the basic value Pbase, the accumulator internal pressure Pacc exceeds the necessary pressure and becomes excessive. This results in unnecessarily prolonging automatic stopping of the engine 12. In the embodiment, when the vehicle 10 is traveling along a congested road, the transmission ECU 80 sets a value that is smaller than the basic value Pbase as the stopping permission threshold Pegstop using the correction value P3. Thus, the timing of the automatic stopping of engine 12 is quickened. The correction value P3 can be set appropriately, while taking into consideration the frequency of automatic stopping of the engine 12 when the vehicle 10 is traveling along a congested road.

When the stopping permission threshold Pegstop is set in this way, the transmission ECU 80 then determines whether the accumulator internal pressure Pacc input in step S100 is equal to or more than the stopping permission threshold Pegstop (step S200). If the transmission ECU 80 determines that the accumulator internal pressure Pacc is not equal to or more than the stopping permission threshold Pegstop, the stopping of the engine 12 is not permitted, and the engine stopping permission determination routine is terminated. If the transmission ECU 80 determines that the accumulator internal pressure Pacc is equal to or more than the stopping permission threshold Pegstop, the stopping permission signal for the engine 12 is transmitted to the engine ECU 116 (step S210), and the engine stop permission determination routine is terminated. Thus, the engine ECU 16 that receives the stopping permission signal stops supplying fuel to the engine 12 and the engine 12 automatically stops, when the automatic stopping conditions for the engine 12 are satisfied. Even if the automatic stopping conditions for the engine 12 are satisfied, the engine ECU 16 does not execute automatic stopping of the engine 12 if the engine ECU 16 does not receive the stopping permission signal. Even if the engine ECU 16 receives the stopping permission signal, the engine ECU 16 does not execute automatic stopping of the engine 12 if the automatic stopping conditions for the engine 12 are satisfied.

The transmission device 20 of the disclosure described above permits automatic stopping of the engine 12 when the accumulator internal pressure Pacc becomes equal to or more than the stopping permission threshold Pegstop. In this transmission device 20, the stopping permission threshold Pegstop can be changed using the correction values P1 to P3 according to the state of the vehicle. Thus, it is possible to optimize the accumulator internal pressure Pacc that permits automatic stopping of the engine 12, to ensure the accumulator internal pressure Pacc necessary for starting the engine 12 and the vehicle 10 again and achieve prompt automatic stopping of the engine 12.

Additionally, the transmission device 20 of the disclosure can release the parking lock by supplying working oil from the accumulator 64 to the parking cylinder 66. In this transmission device 20, when the shift position SP is the parking position, the sum of the hydraulic pressure (correction value P1) necessary for releasing the parking lock and the basic value Pbase is set as the stopping permission threshold Pegstop. Thus, when the shift position SP is the parking position, it is possible to ensure hydraulic pressure necessary for preparation for forming the first forward speed as well as hydraulic pressure for releasing the parking lock. When the shift position SP is not the parking position, the transmission ECU 80 sets the stopping permission threshold Pegstop to which the correction value P1 is not added. Thus, when the shift position SP is not the parking position, the waiting time before the accumulator internal pressure Pacc reaches the stopping permission threshold Pegstop can be reduced and the automatic stopping of the engine 12 can be promptly executed, by reducing the stopping permission threshold Pegstop.

In the transmission device 20 of the disclosure, when the snow mode switch 97 is on, the transmission ECU 80 sets the stopping permission threshold Pegstop that is the sum of the hydraulic pressure necessary for preparation for forming the second forward speed (correction value P2) and the basic value Pbase. Thus, it is possible to ensure the accumulator internal pressure Pacc that is necessary even when the vehicle 10 starts at the second forward speed when the engine 12 starts again. When the snow mode switch 97 is off, the transmission ECU 80 sets the stopping permission threshold Pegstop to which the correction value P2 is not added. When starting the vehicle 10 at the first forward speed, the numbers of the clutches and brakes to be engaged are small compared to the case in which the vehicle starts at the second forward speed. Therefore, it is possible to reduce the waiting time before the accumulator internal pressure Pacc reaches the stopping permission threshold Pegstop, and promptly execute the automatic stopping of the engine 12.

In the transmission device 20 of the disclosure, when the vehicle 10 is traveling along a congested road, the transmission ECU 80 sets the stopping permission threshold Pegstop obtained by subtracting the correction value P3 from the basic value Pbase. When the vehicle 10 is traveling along a congested road, automatic stopping and automatic starting of the engine 12 are repeated. Thus, the amount of working oil that leaks from the accumulator 64 during a period from the time the engine 12 automatically stops to the time the engine 12 automatically starts is thought to be less than usual. Therefore, by reducing the stopping permission threshold Pegstop, the waiting time before the accumulator internal pressure Pacc reaches the stopping permission threshold Pegstop can be reduced and the automatic stopping of the engine 12 can be promptly executed.

In the transmission device 20 of the disclosure, when the shift position SP is the parking position, the transmission ECU 80 sets the stopping permission threshold Pegstop, which is the sum of the basic value Pbase and the correction value P1. However, when the parking lock is released electronically or when the parking lock is released by a physical cable, the correction value P1 does not have to be added, even if the shift position SP is the parking position.

In the transmission device 20 of the disclosure, when the shift position SP is the parking position, the transmission ECU 80 sets the stopping permission threshold Pegstop, which is the sum of the basic value Pbase and the correction value P1. When the snow mode switch 97 is on (when the vehicle 10 is set to start at the second speed), the transmission ECU 80 sets the stopping permission threshold Pegstop, which is the sum of the basic value Pbase and the correction value P2. However, when the shift position SP is the parking position and the snow mode switch 97 is on (when the vehicle 10 is set to start at the second speed), the transmission ECU 80 may set the stopping permission threshold Pegstop which is the sum of the basic value Pbase, the correction value P1, and the correction value P2.

In the transmission device 20 of the disclosure, when the snow mode switch 97 is on (when the vehicle 10 is set to start at the second speed), the transmission ECU 80 sets the stopping permission threshold, which is the sum of the basic value Pbase and the correction value P2. When the transmission ECU 80 determines that the vehicle 10 is traveling along a congested road, the transmission ECU 80 sets the stopping permission threshold Pegstop obtained by subtracting the correction value P3 from the basic value Pbase. However, when the snow mode switch 97 is on (when the vehicle 10 is set to start at the second speed) and the transmission ECU 80 determines that the vehicle 10 is traveling along a congested road, the transmission ECU 80 may set the stopping permission threshold Pegstop obtained by adding the correction value P2 to and subtracting the correction value P3 from the basic value Pbase.

In the transmission device 20 of the disclosure, when the snow mode switch 97 is on, the transmission ECU 80 sets the stopping permission threshold Pegstop, which is the sum of the basic value Pbase and the correction value P2. However, even when the vehicle 10 is set to start at the second speed by a setting means other than the snow mode switch, the transmission ECU 80 may set the stopping permission threshold Pegstop by adding the correction value P2 to the basic value Pbase. For example, suppose the second speed starting shift position for setting the vehicle 10 to start at the second speed is provided as the shift position SP. In this case, the transmission ECU 80 may set the stopping permission threshold Pegstop, which is the sum of the correction value P2 and the basic value Pbase, when the shift position SP is the second speed starting shift position. In this case, the transmission device 20 does not have to include the snow mode switch 97. In the automatic transmission 25 that does not have a second speed starting setting, the correction value P2 does not have to be added.

In the transmission device 20 of the disclosure, the transmission ECU 80 determines whether the vehicle 10 is traveling along a congested road based on the accelerator operation amount Acc, the brake operation amount B, and the vehicle speed V. However, the transmission ECU 80 may determine whether the vehicle 10 is traveling along a congested road based on traffic congestion information obtained from a navigation device.

In the transmission device 20 of the disclosure, when the vehicle 10 is traveling along a congested road, the transmission ECU 80 sets a stopping permission threshold Pegstop obtained by subtracting the correction value P3 from the basic value Pbase. However, the transmission ECU 80 may measure the automatic stopping time of the engine 12 throughout the prescribed number of times and learn it, and then set the stopping permission threshold Pegstop based on the learned automatic stopping time. In this case, the stopping permission threshold Pegstop may be set so that the shorter the automatic stopping time is, the smaller the stopping permission threshold Pegstop will be.

In the transmission device 20 of the disclosure, the transmission ECU 80 sets the stopping permission threshold Pegstop by adding or subtracting the correction values P1 to P3 to or from the basic value Pbase, depending on the state of the vehicle. However, the transmission ECU 80 may set as the stopping permission threshold Pegstop, a threshold selected from the plurality of different thresholds based on the state of the vehicle.

In the transmission device 20 of the disclosure, the accumulator internal pressure Pacc that is compared to the stopping permission threshold Pegstop is detected by the pressure sensor 64a. However, the accumulator internal pressure Pacc may be estimated without the pressure sensor 64a. The estimation of the accumulator internal pressure Pacc can be performed for each of the following states of the accumulator 64: a filling state in which the accumulator 64 is being filled with working oil; a holding state in which working oil is held in the accumulator 64; and a discharging state in which working oil is discharged from the accumulator 64. For example, when the accumulator 64 is in the filling state, the variation per unit time of the hydraulic pressure (filling rate) while the accumulator 64 is being filled with working oil is determined based on the oil temperature (the variation per unit time becomes smaller as the oil temperature decreases, since the lower the oil temperature, the lower the viscosity of the working oil is). Then, the increasing hydraulic pressure is time-integrated by the determined filling rate. Thus, the accumulator internal pressure Pacc can be estimated. Additionally, when the accumulator 64 is in the holding state, the variation per unit time of the hydraulic pressure (leakage rate) when the working oil leaks from the accumulator 64 is determined based on the oil temperature. Then, the decreasing hydraulic pressure is time-integrated by the determined leakage rate. Thus, the accumulator internal pressure Pacc can be estimated. When the accumulator 64 is in the discharging state, the variation per unit time of the hydraulic pressure (discharge rate) when the working oil is discharged from the accumulator 64 is determined based on the oil temperature. Then, the decreasing hydraulic pressure is time-integrated by the determined discharge rate. Thus, the accumulator internal pressure Pacc can be estimated.

In the transmission device 20 of the disclosure, the transmission ECU 80 permits automatic stopping of the engine 12 when the accumulator internal pressure Pacc is equal to or more than the stopping permission threshold Pegstop. However, automatic stopping of the engine 12 may be permitted when the accumulator internal pressure Pacc is equal to or more than the stopping permission threshold Pegstop and the other automatic stopping conditions are satisfied as well.

As described above, the transmission device 20 of the disclosure which is mounted on the vehicle (10) having the motor (12) configured to automatically stop and automatically start, which shifts from the motor (12) with a shift speed that is changed by the engagement and disengagement of the plurality of engagement elements (C1 to C4, B1, B2), and which transmits power to the axle, includes: the hydraulic control device (60) which includes the pump (61) that supplies working oil using power from the motor (12), and the accumulator (64) that accumulates the working oil supplied from the pump (61), and which controls the working oil supplied from the pump or the accumulator to engage the engagement elements (C1 to C4, B1, B2); the start control unit (80) which controls the hydraulic control device (60) so that the working oil accumulated in the accumulator (64) is released to be supplied to the hydraulic servo of the prescribed engagement element (C1, B1) of the engagement elements (C1 to C4, B1, B2), when the motor (12) that automatically stopped starts up with the request for vehicle (10) travel; the accumulator hydraulic pressure acquisition unit which obtains hydraulic pressure of the working oil accumulated in the accumulator; the automatic stop permission unit (80) which permits execution of automatic stopping of the motor (12), when the prescribed condition is satisfied, the condition including that at least the obtained hydraulic pressure in the accumulator (64) has reached the target hydraulic pressure during operation of the motor (12); and the target hydraulic pressure changing unit (80) which changes the target hydraulic pressure based on the state of the vehicle.

By making the target hydraulic pressure variable in this way, it is possible to lower the target hydraulic pressure and cause the motor to automatically stop promptly, when the vehicle is in such a state that the accumulated pressure of the accumulator may be low. Furthermore, when the vehicle is in a state in which a lot of accumulated pressure is needed in the accumulator, it is possible to increase the target hydraulic pressure and sufficiently ensure accumulated pressure in the accumulator.

Additionally, the transmission device 20 may have the shift position sensor (96) that detects the shift position, and the target hydraulic pressure changing unit (80) may change the target hydraulic pressure based on the shift position detected during operation of the motor (12).

In this case, the transmission device 20 may have the parking lock device (66). The parking lock device (66) executes parking lock so that the axle does not rotate when the detected shift position is the parking position, and releases the parking lock using working oil supplied from the pump or the accumulator when the detected shift position is a position other than the parking position. When the shift position detected during operation of the motor (12) is the parking position, the target hydraulic pressure changing unit (80) may change the target hydraulic pressure to a higher hydraulic pressure, compared to the case where the detected shift position is a position other than the parking position.

When the motor (12) that automatically stopped starts up with the starting request of the vehicle (10), the start control unit (80) controls the hydraulic control device (60) so that the first shift speed is formed when the detected shift position is the first traveling position, and controls the hydraulic control device (60) so that the second shift speed is formed when the detected shift position is the second traveling position, the number of engagement elements (C1, B1) that are engaged in the second shift speed being more than that in the first shift speed. When the shift position detected during operation of the motor (12) is the second traveling position, the target hydraulic pressure changing unit (80) may change the target hydraulic pressure to a higher hydraulic pressure, compared to the case where the detected shift position is the first traveling position.

The transmission device 20 may have the starting shift speed setting unit (97) that sets any of the shift speeds in which the number of engagement elements (C1, B1) that are engaged is different, as the shift speed for starting the vehicle (10). When the shift speed for starting the vehicle (10) is set to a shift speed in which the engagement elements (C1, B1) that are engaged is larger, the target hydraulic pressure changing unit (80) can change the target hydraulic pressure to a higher hydraulic pressure, compared to the case where the shift speed is set to a shift speed in which the number of the engagement element (C1) that are engaged is smaller.

The transmission device 20 may have a congested road traveling determination unit (80) that determines that the vehicle (10) is traveling along a congested road. When the congested road traveling determination unit (80) determines that the vehicle (10) is traveling along a congested road, the target hydraulic pressure changing unit (80) changes the target hydraulic pressure to a lower hydraulic pressure, compared to the case where the congested road determination unit does not determine that the vehicle (10) is traveling along a congested road.

The automatic transmission 25 is described to be capable of forming the first to eighth forward speeds and the first and second reverse speeds. However, the exemplary embodiments are not limited to this, and the automatic transmission 25 may be an automatic transmission with any number of shift speeds.

Here, the correspondence between the main elements of the above embodiments and the main elements of the exemplary embodiments will be described. Thus, in the embodiment described above, the engine 12 corresponds to the “motor”, the oil pump 61 corresponds to the “pump”, the accumulator 64 corresponds to the “accumulator”, the hydraulic control device 60 corresponds to the “hydraulic control device”, the transmission ECU 80 corresponds to the “start control unit”, the pressure sensor 64a corresponds to the “accumulator hydraulic pressure acquisition unit”, the transmission ECU 80 which executes the process of steps S200, S210 of the engine stop permission determination routine corresponds to the “automatic stop permission unit”, and the transmission ECU 80 which executes the process of steps S120, S140, and S190 of the engine stop permission determination routine corresponds to the “target hydraulic pressure changing unit”. The shift position sensor 96 corresponds to the “shift position sensor”. The parking lock device which includes the parking cylinder 66 corresponds to the “parking lock device”. The first traveling position corresponds to the “driving position”. The second traveling position corresponds to the “second speed starting shift position”. The snow mode switch 97 corresponds to the “starting shift speed setting unit”. The transmission ECU 80 which executes the process of step S160 of the engine stop permission determination routine corresponds to the “congested road traveling determination unit”.

While modes for carrying out the various aspects of the disclosure have been described above by way of embodiments, the claimed invention of the disclosure is not limited to the embodiments in any way, and it is a matter of course that the aspects of the disclosure may be implemented in various modes without departing from the scope of the various aspects of the disclosure.

### INDUSTRIAL APPLICABILITY

The various aspects of the disclosure is applicable to the manufacturing industry of transmission devices.

1. A transmission device which is mounted on a vehicle having a motor configured to automatically stop and automatically start, which shifts power from the motor with a shift speed that is changed by engagement and disengagement of a plurality of engagement elements, and which transmits the power to an axle, comprising:
a hydraulic control device which has a pump that supplies working oil using power from the motor, and an accumulator that accumulates the working oil supplied from the pump, and which controls the working oil supplied from the pump or the accumulator to engage the engagement elements;
a start control unit which controls the hydraulic control device so that the working oil accumulated in the accumulator is released to be supplied to a hydraulic servo of a prescribed engagement element of the engagement elements, when the motor that automatically stopped starts up with a request for vehicle travel;
an accumulator hydraulic pressure acquisition unit which obtains hydraulic pressure of working oil accumulated in the accumulator;
an automatic stop permission unit that permits execution of automatic stopping of the motor, when a prescribed condition is satisfied, the condition including that at least the obtained hydraulic pressure in the accumulator has reached target hydraulic pressure during operation of the motor; and
a target hydraulic pressure changing unit which changes the target hydraulic pressure based on a state of the vehicle.

2. The transmission device according to claim 1, wherein
the transmission device has a shift position sensor that detects a shift position, and
the target hydraulic pressure changing unit changes the target hydraulic pressure based on the shift position detected during operation of the motor.

3. The transmission device according to claim 2, wherein
the transmission device has a parking lock device which executes a parking lock so that the axle does not rotate when the detected shift position is a parking position, and releases the parking lock using the working oil supplied from the pump or the accumulator when the detected shift position is a position other than the parking position, and
when the shift position detected during operation of the motor is the parking position, the target hydraulic pressure changing unit changes the target hydraulic pressure to a higher hydraulic pressure, compared to the case where the shift position is a position other than the parking position.

4. The transmission device according to claim 3, wherein
when the motor that automatically stopped starts up with a request to start the vehicle, the start control unit controls the hydraulic control device so that a first shift speed is formed when the detected shift position is a first traveling position, and controls the hydraulic control device so that a second shift speed is formed when the detected shift position is a second traveling position, the number of the engagement elements that are engaged in the second shift speed being more than that in the first shift speed, and
when the shift position detected during operation of the motor is the second traveling position, the target hydraulic pressure changing unit changes the target hydraulic pressure to a higher hydraulic pressure, compared to the case where the shift position is the first traveling position.

5. The transmission device according to claim 1, wherein
the transmission device has a starting shift speed setting unit that sets any of the shift speeds in which the number of the engagement elements that are engaged is different, as a shift speed for starting the vehicle, and
when the shift speed for starting the vehicle is set to a shift speed in which the number of the engagement elements that are engaged is larger, the target hydraulic pressure changing unit changes the target hydraulic pressure to a higher hydraulic pressure, compared to the case where the shift speed is set to a shift speed in which the number of the engagement elements that are engaged is smaller.

6. The transmission device according to claim 1, wherein
the transmission device has a congested road determination unit that determines whether the vehicle is traveling along a congested road, and
when the congested road determination unit determines that the vehicle is traveling along a congested road, the target hydraulic pressure changing unit changes the target hydraulic pressure to a lower hydraulic pressure, compared to the case where the congested road determination unit does not determine that the vehicle is traveling along a congested road.

7. The transmission device according to claim 2, wherein
when the motor that automatically stopped starts up with a request to start the vehicle, the start control unit controls the hydraulic control device so that a first shift speed is formed when the detected shift position is a first traveling position, and controls the hydraulic control device so that a second shift speed is formed when the detected shift position is a second traveling position, the number of the engagement elements that are engaged in the second shift speed being more than that in the first shift speed, and
when the shift position detected during operation of the motor is the second traveling position, the target hydraulic pressure changing unit changes the target hydraulic pressure to a higher hydraulic pressure, compared to the case where the shift position is the first traveling position.
